(19) United States
(12) Patent Application Publication
(10) Pub. No.: US 2026/0195045 A1
(43) Pub. Date: Jul. 9, 2026

(54) CONTROLLER, A MEMORY DEVICE AND A DATA STORAGE SYSTEM

(71) Applicant: SK hynix Inc., Icheon-si (KR)

(72) Inventor: Dong Sop LEE, Icheon-si (KR)

(21) Appl. No.: 19/228,295

(22) Filed: Jun. 4, 2025

(30) Foreign Application Priority Data
Jan. 8, 2025 (KR) 10-2025-0002522

(51) Int. Cl. G06F 3/06

(52) U.S. Cl. CPC G06F 3/061; G06F 3/0659; G06F 3/0673

(57) ABSTRACT

A data storage system is disclosed that improves access performance to a memory device by a memory device having a plurality of channels, and improves the operation performance, prevents operation errors and improves efficiency by controlling the transmission timing of an operation command to a storage area based on occupancy status information of a storage area included in the memory device.

### CROSS-REFERENCE TO RELATED APPLICATION

The present application claims priority under 35 U.S.C. §119(a) to Korean patent application number 10-2025-0002522 filed in the Korean Intellectual Property Office on January 8, 2025, which is incorporated herein by reference in its entirety.

### TECHNICAL FIELD

Embodiments of the present disclosure relate to a controller, a memory device, and a data storage system.

### BACKGROUND

A data storage system may include at least one memory device that stores data. The data storage system may include a controller that controls the operation of at least one memory device. The controller may access the memory device and control the operation of the memory device according to a command received from an external device.

The operational performance of the data storage system may be displayed depending on the time taken for the controller to access the memory device and process the command received from the outside. The number of memory devices included in the data storage system may be limited. Accordingly, a method for improving the operational performance of the data storage system while using limited memory devices is required.

### SUMMARY

The objectives of the embodiments of the present disclosure are not limited to those explicitly stated herein. Additional objectives not explicitly mentioned will be apparent to those skilled in the art from the descriptions provided below.

The embodiments of the present disclosure may provide a method for reducing the time required for a controller included in a data storage system to access a memory device and process a command received from the outside, and improving the operational performance of the data storage system.

The embodiments of the present disclosure may provide a data storage system including: a plurality of storage areas, including a first storage area and a second storage area, for storing data; a memory device including a first channel and a second channel for communication; and a controller for transmitting an operational command to the memory device through at least one of the first channel and the second channel and for controlling an operation for the first storage area through the first channel during a first time period and controlling an operation for the second storage area through the second channel during a portion of the first time period.

Embodiments of the present disclosure may provide a memory device including a plurality of storage areas, and a switching unit that controls connections between each of the plurality of storage areas and N (where N is an integer equal to or greater than 2) channels, wherein the memory device receives an operation command for a first storage area through a first channel, from among the N channels and receives an operation command for a second storage area different from the first storage area through a second channel during at least a portion of a period during which an operation for the first storage area is performed.

Embodiments of the present disclosure may provide a controller including: an interface unit that communicates with a memory device through a first channel and a second channel; and a control logic that transmits an occupation request command for a target storage area through the first channel, checks occupation status information of the target storage area, and transmits an operation command for the target storage area through the first channel if the occupation status information of the target storage area is a first value.

According to embodiments of the present disclosure, the operational performance of a data storage system may be improved by setting occupation status information for each storage area included in the memory device and allowing the controller to access the storage areas through a plurality of channels.

The advantages of the embodiments of the present disclosure are not limited to those mentioned above, but other advantages not mentioned will be clearly understood by those skilled in the art from the description of the claims.

### BRIEF DESCRIPTION OF THE DRAWINGS

The present disclosure will be more fully understood from the detailed description and accompanying drawings provided below, which are provided solely for the purpose of explanation and are not intended to limit the content of the present disclosure.

FIG. 1 is a schematic configuration diagram of a data storage system according to embodiments of the present disclosure.

FIG. 2 shows an example of a memory device and a controller included in a data storage system according to embodiments of the present disclosure.

FIGS. 3 to 5 show examples of operation methods of a memory device and a controller illustrated in FIG. 2.

FIG. 6 shows another example of a memory device and a controller included in a data storage system according to embodiments of the present disclosure.

FIGS. 7 and 8 show examples of operation methods of a memory device and a controller illustrated in FIG. 6 according to embodiments of the present disclosure.

FIG. 9A and FIG. 9B show examples of connection structures of a memory device and a controller included in a data storage system according to embodiments of the present disclosure.

FIG. 10 shows an example of a configuration implementing a computing system including a data storage system according to embodiments of the present disclosure.

### DETAIL DESCRIPTION OF THE EXEMPLARY EMBODIMENTS

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure rather more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element may be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, or manufacturing methods, these terms may be used to describe non-consecutive or non-sequential processes or operations unless the term "directly" or "immediately" is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompass all the meanings of the term “can”.

Hereinafter, various embodiments of the present disclosure will be described in detail with reference to accompanying drawings.

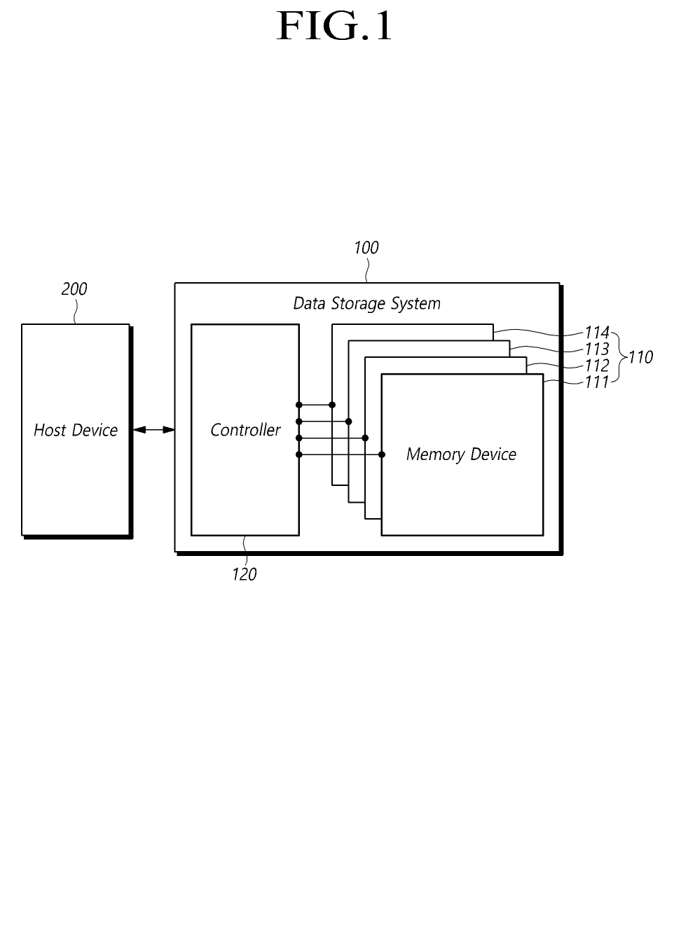

FIG. 1 illustrates a schematic configuration diagram of a data storage system according to embodiments of the present disclosure.

Referring to FIG. 1, a data storage system 100 may include at least one memory device 110. FIG. 1 exemplarily illustrates a case in which the data storage system 100 includes a first memory device 111, a second memory device 112, a third memory device 113, and a fourth memory device 114, but embodiments of the present disclosure are not limited thereto. The data storage system 100 may include a controller 120 that controls the operation of the memory device 110.

The memory device 110 may be, for example, a volatile memory such as DRAM, SDRAM, DDR SDRAM, LPDDR SDRAM, etc., but the embodiments of the present disclosure are not limited thereto. The memory device 110 may also be a nonvolatile memory such as NAND flash memory, 3D NAND flash memory, NOR flash memory, etc. In addition, in some cases, some parts of the memory devices 110 included in the data storage system 100 may be volatile memories, and other parts may be nonvolatile memories.

In addition, the memory device 110 may be one of various types of memories such as resistive RAM, phase change memory, magnetoresistive memory, ferroelectric memory, or spin injection magnetization reversal memory.

In addition, the memory device 110 may also be a processing-in-memory including an operation function or a data processing function, in some cases. The configuration performing the computational function in the memory device 110 may be located inside a bank of the memory device 110 or may be located outside the bank. When located outside the bank, the configuration performing the computational function may be located adjacent to the bank or may be located in an area spaced apart from the bank.

The controller 120 may control the operation of the memory device 110 based on a command received from the outside (e.g., an external command). The controller 120 may control the operation of the memory device 110 based on its own command (e.g., an internal command).

The controller 120 may transmit commands, addresses, data, etc. for controlling the operation of the memory device 110 to the memory device 110. The controller 120 may control, for example, an operation of writing data to the memory device 110. The controller 120 may control an operation of reading data written to the memory device 110.

The controller 120 may control a refresh operation or an erase operation for data written to the memory device 110, depending on the type of the memory device 110.

The controller 120 may perform an operation for detecting and correcting an error for data read from the memory device 110. In some cases, operations for error correction may be performed inside the memory device 110.

The controller 120 may control the operation of the memory device 110 based on a command received from an external host device 200.

The host device 200 may be, for example, a computer, an Ultra Mobile PC (UMPC), a workstation, a Personal Digital Assistant (PDA), a tablet, a mobile phone, a smart phone, an e-book, a Portable Multimedia Player (PMP), a portable game console, a navigation device, a black box, a digital camera, a Digital Multimedia Broadcasting (DMB) player, a smart television, a digital voice recorder, a digital voice player, a digital video recorder, a digital video player, a storage constituting a data center, one of various electronic devices constituting a home network, one of various electronic devices constituting a telematics network, a Radio Frequency Identification (RFID) device, a mobile device, such as a vehicle, a robot, a drone, that drives under human control or can drive autonomously, etc. Alternatively, the host device 200 may be a virtual/augmented reality device that provides two-dimensional or three-dimensional virtual reality images or augmented reality images. In addition to the examples described above, the host device 200 may be any one of various electronic devices that require a data storage system 100 capable of storing data for data processing.

The host device 200 may include at least one operating system. The operating system may manage and control the overall functions and operations of the host device 200 and may control the mutual operations between the host device 200 and the data storage system 100. The operating system may be classified into a general operating system and a mobile operating system according to the mobility of the host device 200.

The controller 120 and the host device 200 may be separate devices. In some cases, the controller 120 and the host device 200 may be implemented by being integrated into one device. Below, for the convenience of explanation, the controller 120 and the host device 200 are described as separate devices as an example.

The controller 120 may communicate with each memory device 110 through at least one channel and control the operation of the memory device 110. The controller 120 may, in some cases, communicate with each memory device 110 through multiple channels and control the operation of the memory device 110. The controller 120 may access each memory device 110 through two or more channels and control the operation of the memory device 110, thereby improving the operation performance of the data storage system 100.

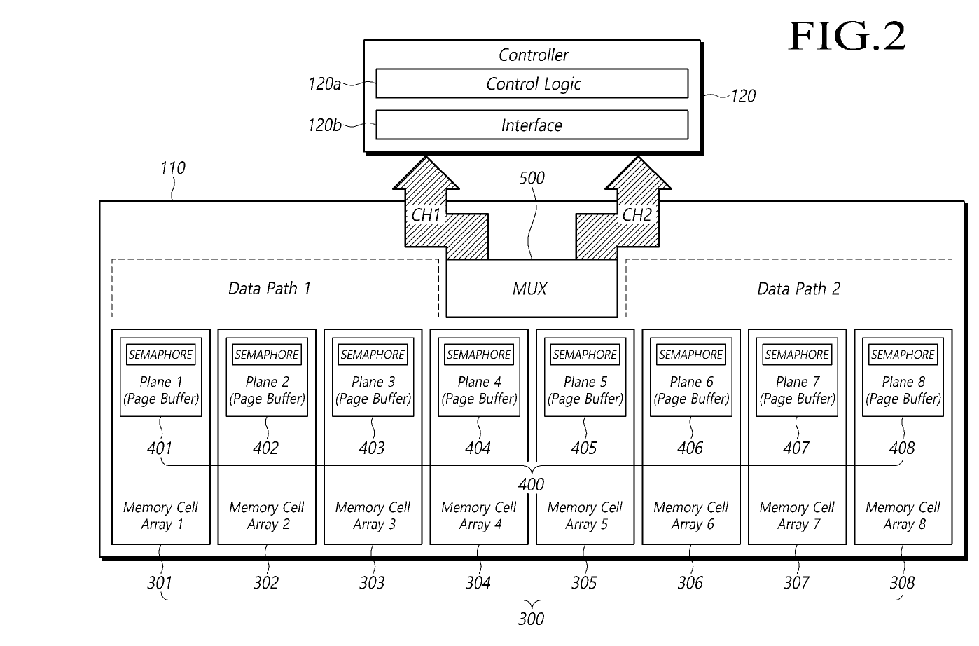

FIG. 2 shows an example of a memory device and a controller included in a data storage system according to embodiments of the present disclosure.

Referring to FIG. 2, a memory device 110 may include at least one memory cell array 300. The memory cell array 300 may include multiple memory cells that store data. The memory cell array 300 may include a plurality of word lines and a plurality of bit lines to which signals for driving the memory cells are applied. Two or more memory cells may constitute a storage area.

As an example, each of the memory cell arrays 300 may include a plurality of storage blocks. Each of the plurality of storage blocks may include a plurality of planes 400. Each of the plurality of planes 400 may include a plurality of pages. Each of the plurality of pages may include a plurality of memory cells. In the present specification, a plane 400 is described as a unit storage area or a storage area, but a storage area according to the embodiments of the present disclosure may mean one of the memory cell arrays 300 or various unit storage spaces included in the memory cell array 300.

As illustrated in FIG. 2, a plurality of memory cell arrays 300 may include a first memory cell array 301, a second memory cell array 302, a third memory cell array 303, a fourth memory cell array 304, a fifth memory cell array 305, a sixth memory cell array 306, a seventh memory cell array 307, and an eighth memory cell array 308, but embodiments of the present disclosure are not limited to the number and configuration of memory cell arrays in FIG. 2.

The plurality of memory cell arrays 300 may include a plurality of planes 400, which may include a page buffer for storing data written or read in a corresponding area. The plane 400 may store occupation status information for managing access of a channel to a storage area. The occupation status information may be referred to as a semaphore, and the occupation status information may be stored in a part of an area of a storage area that is a unit accessed by a controller 120. Alternatively, in some cases, the occupation status information may be stored in a specific area located in the plane 400 within the memory cell array 300. Access to the storage area through a plurality of channels may be managed and controlled based on the occupation status information of each storage area.

For example, the memory device 110 may communicate with the controller 120 through a first channel CH1 and a second channel CH2. In some cases, the memory device 110 may communicate with the controller 120 through three or more channels. The memory device 110 may include a multiplexer 500, and the connection between the channels and each storage area may be controlled through the multiplexer 500. The multiplexer 500 may be referred to as a switching unit. Data paths through which signals are transmitted and received may be arranged around the multiplexer 500 or between the multiplexer 500 and the storage area. A plurality of wires may be arranged in the data paths, and the connection between each channel and the storage area may be controlled according to the operation of the multiplexer 500.

The controller 120 may access the memory device 110 through the first channel and the second channel and control the operation of the memory device 110. The controller 120 may include, for example, a control logic 120a and an interface unit 120b.

The interface unit 120b of the controller 120 may communicate with the memory device 110 through at least one of the first channel and the second channel. The control logic 120a of the controller 120 may access the memory device 110 through the first channel or the second channel and control operations for a plurality of storage areas included in the memory device 110. When accessing the storage area, the control logic 120a may perform access to the storage area based on occupation status information stored in the storage area. The occupation status information may be information set for each storage area.

As an example, the control logic 120a may communicate with the memory device 110 through the first channel. The control logic 120a may request access to some of the storage areas among the plurality of storage areas included in the memory device 110. The storage area that is the target of the access request may be referred to as a target storage area. The memory device 110 may check the occupation status of the storage area requested for access. The memory device 110 may check the occupation status information stored or set in the corresponding target storage area, and if it is not occupied, may allocate the target storage area to the channel to which access has been requested. If the corresponding target storage area is occupied, the memory device 110 may provide information about the occupied status to the controller 120.

The control logic 120a may access the memory device 110 through a plurality of channels, check the occupation status information of the storage area to which access is requested by each of the plurality of channels, and perform access to each storage area accordingly. For example, the control logic 120a may access the memory device 110 through the first channel in a first time period. And the control logic 120a may access the memory device 110 through the second channel in at least a portion of the first time period. The operational speed may be improved by accessing through a plurality of channels, and shared access to the storage area through a plurality of channels can be efficiently performed by managing the occupation status information set for each storage area.

Before controlling an operation according to a write command or a read command, the control logic 120a may transmit at least one command to the memory device 110 to check the occupation status information of the storage area that is the target of the operation, and then may control the operation according to the write command or the read command. In the present specification, a command that instructs an operation directly performed on the storage area, such as a write command or a read command, may be referred to as an operation command.

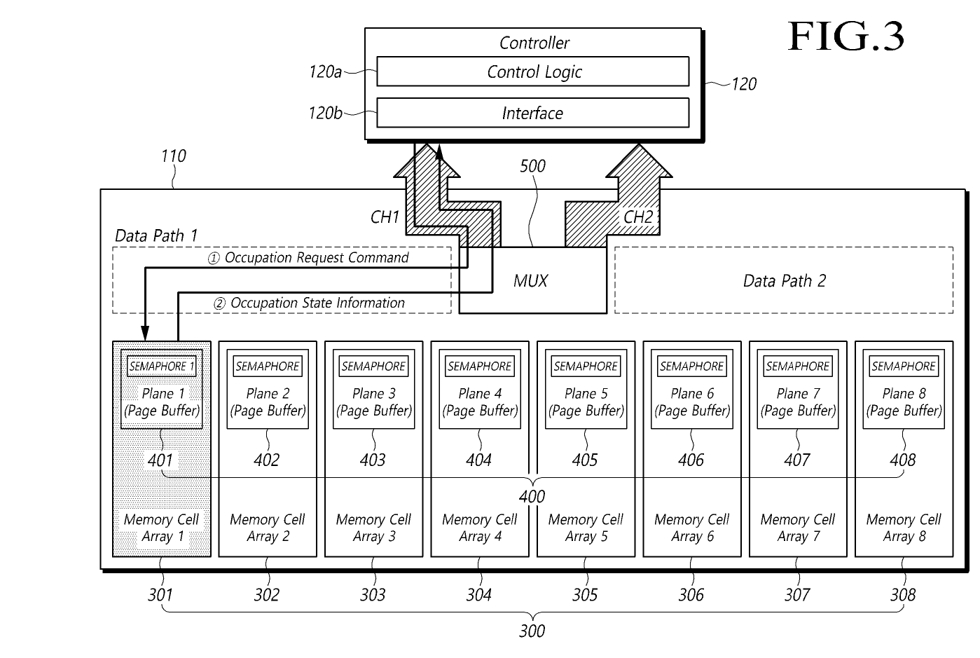

FIGS. 3 to 5 show examples of operation methods of a memory device and a controller illustrated in FIG. 2.

Referring to FIG. 3, to check occupation status information, a controller 120 may transmit an occupation request command to a memory device 110 through at least one of a first channel and a second channel in order to access the memory device 110.

For example, the controller 120 may transmit an occupation request command to the memory device 110 through the first channel. The controller 120 may transmit, to the memory device 110, an occupation request command for a first storage area from among a plurality of storage areas included in the memory device 110 (①). The first storage area may be referred to as a target storage area.

For example, the first storage area may be a first plane 401 included in a first memory cell array 301 included in the memory device 110. In some cases, the first storage area may be the first memory cell array 301 or a storage area of a unit smaller than the first plane 401.

The memory device 110 may check the occupation status information of the first storage area according to the occupation request command from the controller 120. The memory device 110 may transmit the occupation status information to the controller 120 in response to the occupation request command of the controller 120 (②).

The first storage area may be in an unoccupied state, or may be occupied through another channel.

The memory device 110 may allocate the first storage area to the first channel if the first storage area is in an unoccupied state. For example, the occupation status information of the first storage area may be set to, for example, a first value. The first value may mean a state in which the corresponding storage area is allocated to the first channel.

The memory device 110 may set the occupation status information of the first storage area to the first value and may transmit the occupation status information of the first storage area to the controller 120. After receiving the occupation status information of the first storage area, the controller 120 may transmit an operation command for the first storage area. The controller 120 may transmit a write command or a read command for the first storage area to the memory device 110. Thus, before performing control according to the operation command, the controller 120 may first transmit an occupation request command for the corresponding storage area and then may perform control according to the operation command based on the occupation status information of the corresponding storage area. The controller 120 may control an operation through the second channel during a portion of a time period to control an operation through the first channel.

As another example, the first storage area may be in a state allocated by another channel. The first storage area may be in a state allocated to the second channel. The occupation status information of the first storage area may be set to, for example, a second value. An operation may be performed according to a command transmitted, through the second channel, in the first storage area.

The memory device 110 may provide the controller 120 with the information that the occupation status information set in the first storage area is the second value and therefore allocated to a second channel. In this example, the controller 120 does not transmit an operation command for the first storage area based on the occupation status information received from the memory device 110. The controller 120 may control an operation for a different storage area through the first channel. The controller 120 may retransmit an occupation request command for the first storage area at a different time.

The controller 120 may transmit an operation command to the memory device 110 during a first time period when the occupation status information of the first storage area is determined to be a first value. The controller 120 may transmit an operation command to the memory device 110 during a second time period, which is later than the first time period, when the occupation status information of the first storage area is determined to be a second value. The controller 120 may first transmit an occupation request command to the memory device 110 before transmitting the operation command in the second time period.

As described above, the controller 120 may transmit the operation command after receiving the occupation status information in response to the occupation request command. In other embodiments, the controller may further transmit a command that requires a check of the occupation status information before proceeding with an operation command.

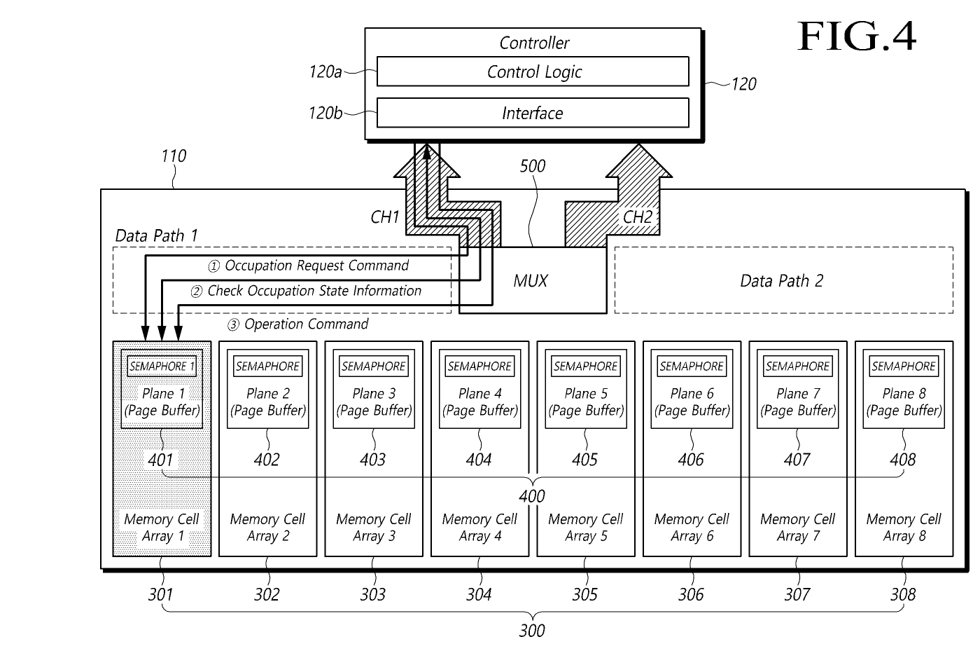

As an example, referring to FIG. 4, a controller 120 may transmit an occupation request command for a first storage area to the memory device 110 through the first channel (①). The first storage area may be a first plane 401, but examples are not limited thereto.

The memory device 110 may check the occupation status information of the first storage area. If the first storage area is not occupied, then the memory device 110 may set the occupation status information of the first storage area to the first value.

The controller 120 may transmit a command requesting confirmation of the occupation status information of the first storage area to the memory device 110 through the first channel after transmitting the occupation request command (②).

The controller 120 may verify the occupation status information of the first storage area in response to the command requesting confirmation of the occupation status information of the first storage area. The memory device 110 may transmit the first value to the controller 120 in response to the command of the controller 120.

The controller 120 may verify that the occupation status information of the first storage area is set to the first value, and transmit an operation command for the first storage area to the memory device 110 (③).

The controller 120 transmits an occupation request command to the memory device 110 and then transmits a command to check the occupation status information of the corresponding storage area before transmitting an operation command. Thus, errors caused by accessing the same storage area through the first channel and the second channel may be prevented or reduced.

The controller 120 transmits an occupation request command for the first storage area through the first channel, and then transmits an operation command to the memory device 110 in the first time period if the occupation status information of the first storage area is a first value. Accordingly, operation of the first storage area may be controlled.

In other embodiments, the controller 120 may transmit a corresponding operation command to the memory device 110 at a time period other than the first time period if the occupation status information of the first storage area is a value other than a first value.

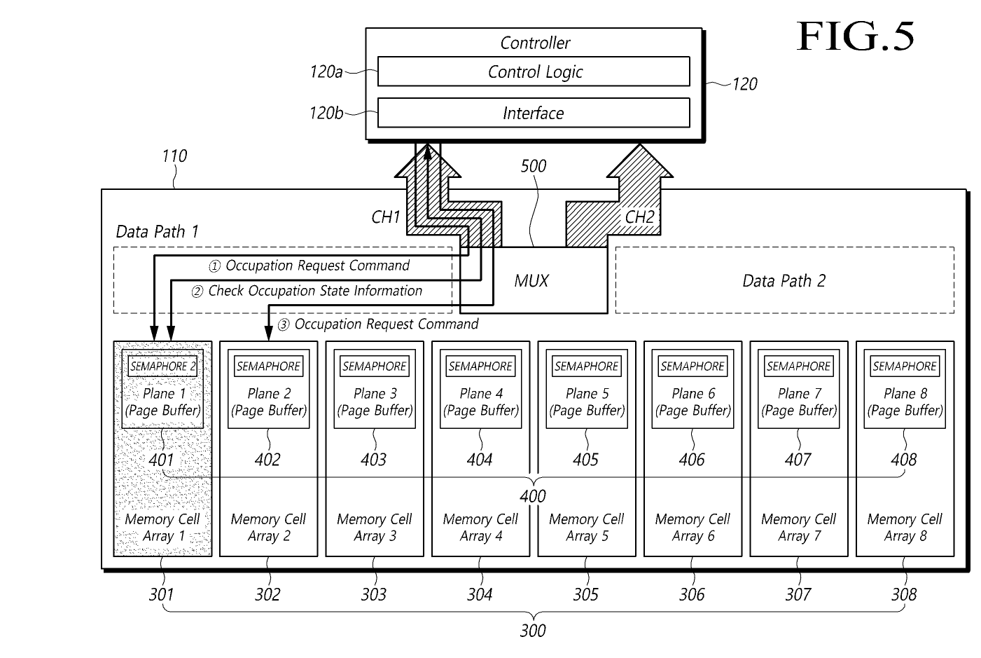

For example, referring to FIG. 5, a controller 120 may transmit an occupation request command for the first storage area to the memory device 110 through the first channel (①). The first storage area may be a first plane 401, but embodiments are not limited thereto.

The memory device 110 may check the occupation status information of the first storage area. The occupation status information of the first storage area may be a second value, which means that the first storage area may be in a state allocated to the second channel. An operation may be in progress using the second channel to control the first storage area according to an operation command.

The controller 120 may transmit a command requesting confirmation of the occupation status information of the first storage area to the memory device 110 through the first channel (②). The controller 120 may receive the occupation status information of the first storage area in response to the command, which verifies that the occupation status information of the first storage area is the second value.

Since the occupation status information of the first storage area is the second value, the controller 120 may adjust the timing of transmitting an operation command to the first storage area. The controller 120 may transmit the operation command to the first storage area at a second time period that is later than a first time period.

The controller 120 may not perform communication through the first channel until the second time period. Alternatively, the controller 120 may attempt to access another storage area through the first channel.

As an example, the controller 120 may transmit, to the memory device 110, an occupation request command for a second storage area through the first channel (③). The second storage area may be a second plane 402, but embodiments are not limited thereto.

According to the occupation request command from the controller 120, the memory device 110 may check the occupation status information of the second storage area. If the second storage area is not occupied, then the memory device 110 may allocate the second storage area to the first channel and set the occupation status information of the second storage area to the first value. If the second storage area is allocated to the second channel, then the memory device 110 may maintain the occupation status information of the second storage area as the second value.

After transmitting the occupation request command for the second storage area through the first channel, the controller 120 may transmit a command requesting confirmation of the occupation status information of the second storage area to the memory device 110 through the first channel. If the occupation status information of the second storage area is confirmed to be the first value, then the controller 120 may transmit an operation command for the second storage area to the memory device 110 through the first channel. If the occupation status information of the second storage area is confirmed to be the second value, then the controller 120 may transmit an operation command for the second storage area to the memory device 110 at a different time period.

The controller 120 may access the memory device 110 through the first channel and the second channel and control the operation of the memory device 110, thereby improving the operational performance of the data storage system 100. Since the controller 120 checks the occupation status information of each storage area included in the memory device 110 and controls the operation of the corresponding storage area, access errors can be prevented and the efficiency of operation can be improved when controlling through multiple channels.

In addition, since the memory device 110 communicates with the controller 120 through multiple channels, the memory device 110 may be controlled by multiple controllers 120 in some cases.

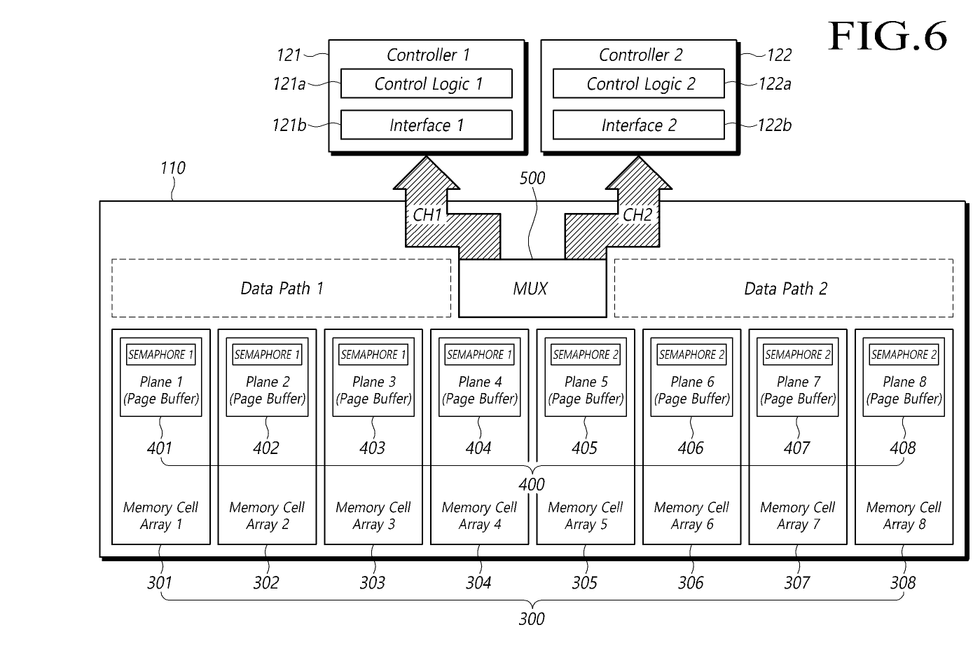

FIG. 6 shows another example of a memory device and a controller included in a data storage system according to embodiments of the present disclosure.

Referring to FIG. 6, a data storage system 100 may include a first controller 121, a second controller 122, and a memory device 110. The first controller 121 may include first control logic 121a and a first interface unit 121b. The second controller 122 may include second control logic 122a and a second interface unit 122b.

The memory device 110 may include a plurality of memory cell arrays 300. Each of the plurality of memory cell arrays 300 may include a plane. A memory cell array 300 or a plane 400 may correspond respectively to a plurality of memory cell arrays in the storage area.

The memory device 110 may communicate with the first controller 121 and the second controller 122 through a plurality of channels. For example, the memory device 110 may communicate with the first controller 121 or the second controller 122 through at least one of a first channel and a second channel.

For example, the first controller 121 may communicate with the memory device 110 through the first channel. The first controller 121 may occupy the first channel. The second controller 122 may communicate with the memory device 110 through the second channel. The second controller 122 may occupy the second channel.

In some cases, when the number of channels included in the memory device 110 is two or more, the first controller 121 or the second controller 122 may access the memory device 110 through two or more channels. For example, the first controller 121 may access the memory device 110 through two or more channels. And the second controller 122 may access the memory device 110 through two or more channels, also.

The first controller 121 may communicate with the memory device 110 through the first channel and access the storage area included in the memory device 110. A period that the first controller 121 communicates with the memory device 110 through the first channel may overlap with a period that the second controller 122 communicates with the memory device 110. Alternatively, the period that the first controller 121 communicates with the memory device 110 through the first channel may be different from the period that the second controller 122 communicates with the memory device 110 through the second channel.

For example, the first controller 121 may transmit an occupation request command for the first storage area through the first channel. The memory device 110 may check the occupation status information set for the first storage area. If the first storage area is not occupied, then the memory device 110 may set the occupation status information of the first storage area to the first value. If the first storage area is occupied by the second channel, then the memory device 110 may maintain the occupation status information of the first storage area as the second value.

After transmitting the occupation request command for the first storage area, the first controller 121 may transmit a command requesting confirmation of the occupation status information of the first storage area to the memory device 110 through the first channel. If the occupation status information of the first storage area is verified as the first value, then the first controller 121 may transmit an operation command to the memory device 110 through the first channel. Depending on the operation command, an operation may be performed to write data to the first storage area or read data written to the first storage area.

The first controller 121 may adjust the timing of transmitting the operation command for the first storage area if the occupation status information of the first storage area is the second value. The timing of the first controller 121 transmitting the operation command may vary depending on the occupation status information of the first storage area.

Similar to the first controller 121, the second controller 122 may check the occupation status information of the storage area by transmitting an occupation request command through the second channel, and then may transmit an operation command for the corresponding storage area to the memory device 110 through the second channel. In some cases, the second controller 122 may receive the occupation status information of the storage area as a response for the occupation request command.

Each of the first controller 121 and the second controller 122 can communicate through the first channel and the second channel, set the occupation status information of the storage area, and control the operation of the storage area. Accordingly, command processing performance can be improved, errors due to simultaneous control of the first controller 121 and the second controller 122 can be prevented, and the operation efficiency of the memory device 110 can be improved.

When each of the first controller 121 and the second controller 122 occupies separate channels and accesses the memory device 110, the default value of the occupation status information of some of the plurality of storage areas may be set to the first value, and the default value of the occupation status information of the remaining storage areas may be set to the second value, but the embodiments of the present disclosure are not limited thereto.

Since the first controller 121 and the second controller 122 may both access multiple storage areas included in the memory device 110 through either channel, data may be shared between the controllers 120 through the storage areas.

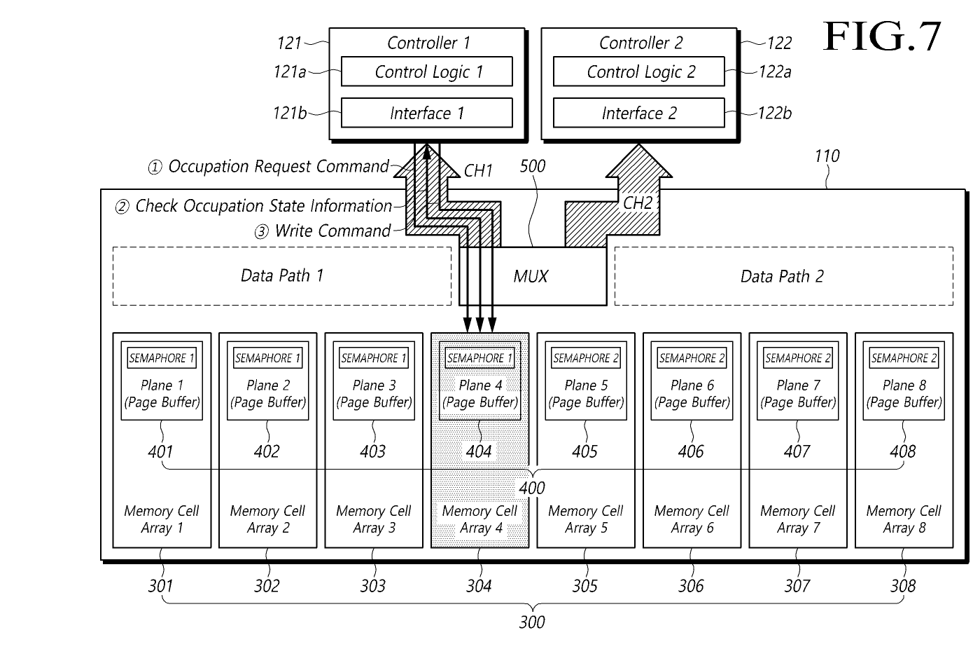

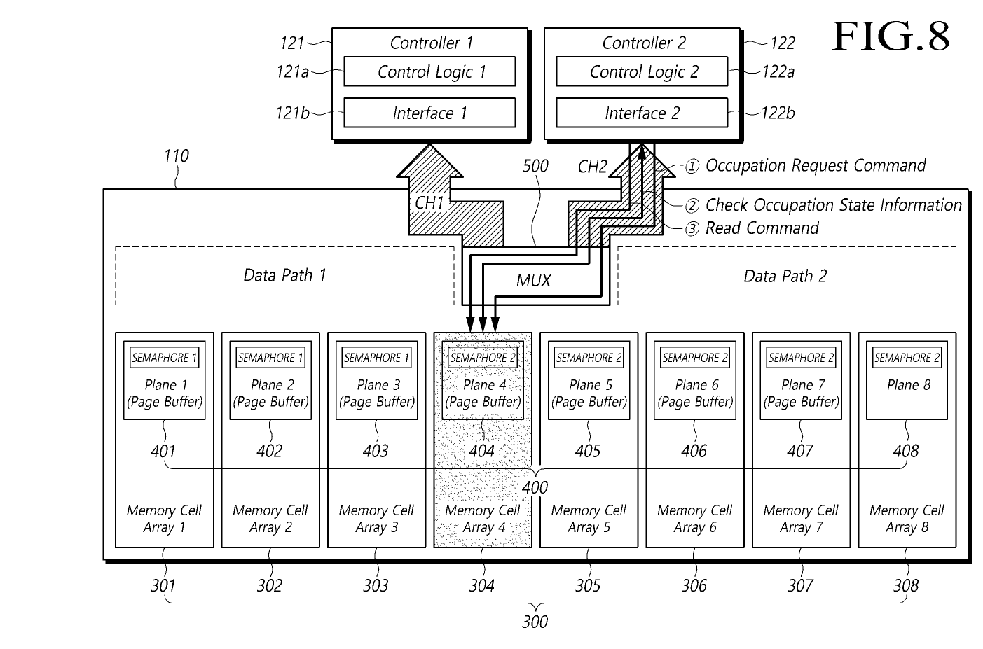

FIG. 7 and FIG. 8 show examples of operation methods of a memory device and a controller illustrated in FIG. 6 according to embodiments of the present disclosure.

Referring to FIG. 7, a first controller 121 may transmit an occupation request command for a first storage area to a memory device 110 through a first channel during a first time period (①). The first storage area may be, for example, fourth plane 404 included in a fourth memory cell array 304.

The memory device 110 may check the occupation status information of the fourth plane 404. The memory device 110 may set the occupation status information of the fourth plane 404 to the first value if the fourth plane 404 is not occupied.

The first controller 121 may transmit a command requesting confirmation of the occupation status information of the first storage area to the memory device 110 through the first channel after transmitting the occupation request command (②).

The first controller 121 may verify that the occupation status information of the fourth plane 404, which is the first storage area, is the first value. The first controller 121 may transmit an operation command for the first storage area through the first channel (③). The operation command for the first storage area may be a write command. Under the control of the first controller 121, data may be written to the first storage area.

The second controller 122 may access the same first storage area that is accessed by the first controller 121.

For example, referring to FIGS. 7 and 8, the second controller 122 may transmit an occupation request command for the same first storage area to the memory device 110 through the second channel (①). If the occupation request command of the second controller 122 is received during the first time period, in which a write operation is performed on the first storage area under the control of the first controller 121, then the memory device 110 may maintain the occupation status information of the first storage area as the first value. The second controller 122 may check the occupation status information of the first storage area and adjust the timing of transmitting an operation command for the first storage area.

Subsequently, the second controller 122 may transmit an occupation request command for the first storage area to the memory device 110 through the second channel during a second time period, which is after the first time period.

The memory device 110 may set the occupation status information of the first storage area to the second value according to the occupation request command of the second controller 122 after the write operation for the first storage area under the control of the first controller 121 is completed.

The second controller 122 may transmit a command requesting confirmation of the occupation status information of the first storage area to the memory device 110 through the second channel (②).

The second controller 122 may verify that the occupation status information of the first storage area is the second value. The second controller 122 may transmit an operation command for the first storage area through the second channel (③). The operation command for the first storage area may be a read command. The second controller 122 may access the first storage area and read data stored in the first storage area. If the occupation status information of the first storage area is not the second value, the second controller 122 may transmit an occupation request command for another storage area. Alternatively, the second controller 122 may transmit the occupation request command for the first storage area repeatedly.

Since the memory device 110 provides multiple channels, one or more controllers 120 may communicate with the memory device 110 and control the operation of the memory device 110.

When multiple controllers 120 access the memory device 110, they may access the memory device 110 through at least one separately allocated channel. Since multiple controllers 120 may each access multiple storage areas included in the memory device 110, data may be easily shared between multiple controllers 120 connected to the memory device 110 by setting occupation status information of each of the multiple storage areas and transmitting an operation command.

Because the memory device 110 supports multiple channels, a structure in which the controller 120 is connected to the memory device 110 may vary, and the memory device 110 and the controller 120 may be connected in various ways depending on the number of memory devices 110, the number of channels, the number of controllers 120 and the number of channels included in the data storage system 100.

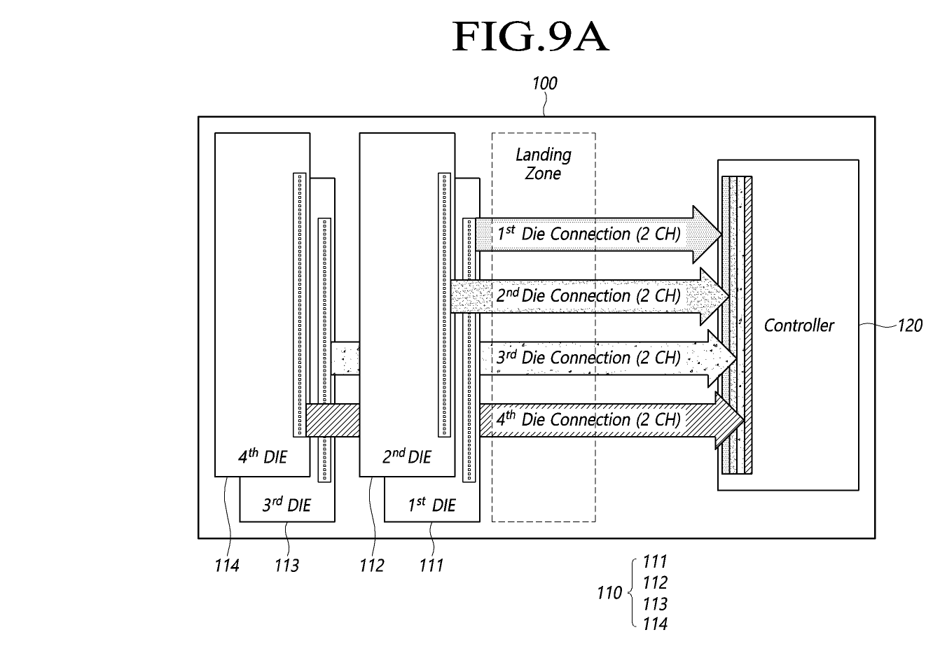

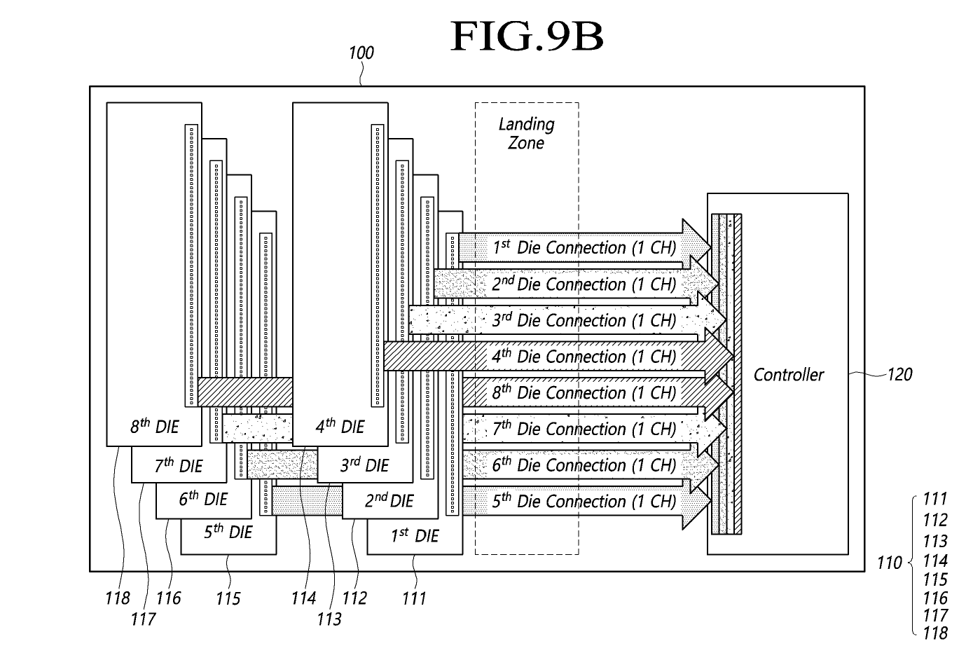

FIG. 9A and FIG. 9B show examples of connection structures of a memory device and a controller included in a data storage system according to embodiments of the present disclosure.

Referring to FIG. 9A, a data storage system 100 may include a controller 120 and a memory device 110 that may include, for example, a first memory device 111, a second memory device 112, a third memory device 113, and a fourth memory device 114. Each memory device 110 may be referred to as a memory die.

Each memory device 110 may communicate through multiple channels. For example, each memory device 110 may include two channels. The memory device 110 may communicate with the controller 120 through a first channel and a second channel.

The controller 120 may communicate with the memory device 110 through multiple channels. For example, the controller 120 may include eight channels.

The controller 120 may communicate with the first memory device 111 through two out of the eight channels. The controller 120 may communicate with each of the remaining memory devices (112, 113 and 114) using two channels each.

For example, the controller 120 may communicate with each memory device 111 to 114 using two channels for each memory device, and may first transmit an occupation request command for a target storage area of an operation command while communicating through a channel. The controller 120 may set occupation status information of the storage area through either channel (at least one of each channel), transmit an operation command through a channel allocated according to the occupation status information, and control the operation for the corresponding storage area.

The number of channels included in the controller 120 may be greater than the number of channels included in the memory device 110, or the number of channels included in the memory device 110 may be greater than the number of channels included in the controller 120. If the number of channels included in the memory device 110 is greater than the number of channels included in the controller 120, then the controller 120 may communicate with each memory device 110 using some of the channels of the memory device 110.

As an example, referring to FIG. 9B, the data storage system 100 may include a controller 120 and a memory device 110 including a plurality of memory devices 111 through 118. FIG. 9B illustrates an example in which the plurality of memory devices 110 is eight, but other embodiments are not limited to eight.

The memory device 110 may include a plurality of channels. As an example, each of the memory devices 110 may include two channels. Therefore, the total number of channels of the memory devices 110 included in the data storage system 100 may be 16.

The controller 120 may have eight channels, as in FIG. 9A. When the sum of the number of channels included in the memory device 110 is N, and the number of channels included in the controller 120 is less than N, the controller 120 may communicate with the memory device 110 through some of the channels of the memory device 110.

As an example, when each memory device 111 through 118 includes a first channel and a second channel, the controller 120 may communicate with some of the memory devices through the first channel and with the remaining memory devices through the second channel. As an example, the controller 120 may communicate with the first memory device 111, the second memory device 112, the third memory device 113, and the fourth memory device 114 through the first channel. The controller 120 may communicate with the fifth memory device 115, the sixth memory device 116, the seventh memory device 117, and the eighth memory device 118 through a second channel.

Even when the controller 120 communicates with each memory device 110 using only one channel, it may transmit an occupation request command before transmitting an operation command, as in the descriptions disclosed herein of multiple-channel communication. The controller 120 may access a storage area included in the memory device 110 with a consistent process, regardless of the number of memory devices 110. In this case, all occupation status information of the storage area included in the memory device 110 communicating through the first channel may be set to the first value. All occupation status information of the storage area included in the memory device 110 communicating through the second channel may be set to the second value. The controller 120 may check the occupation status information through a check occupation state request and control the operation of the corresponding storage area by transmitting the operation command.

In addition to the above-described example, some of the plurality of memory devices 110 may communicate with the controller 120 through a single channel, and the rest may communicate with the controller 120 through multiple channels. In a structure where the memory device 110 includes multiple channels, the number of channels through which the memory device 110 communicates with the controller 120 may vary. Operational efficiency of the multi-channel memory device 110 can be improved nevertheless through the process of checking the occupation status information.

The operation performance of a computing system that performs data processing using the data storage system 100 can be improved by providing multiple channels in the data storage system 100 including the memory device 110. The computing system may also be implemented in the form of a single package.

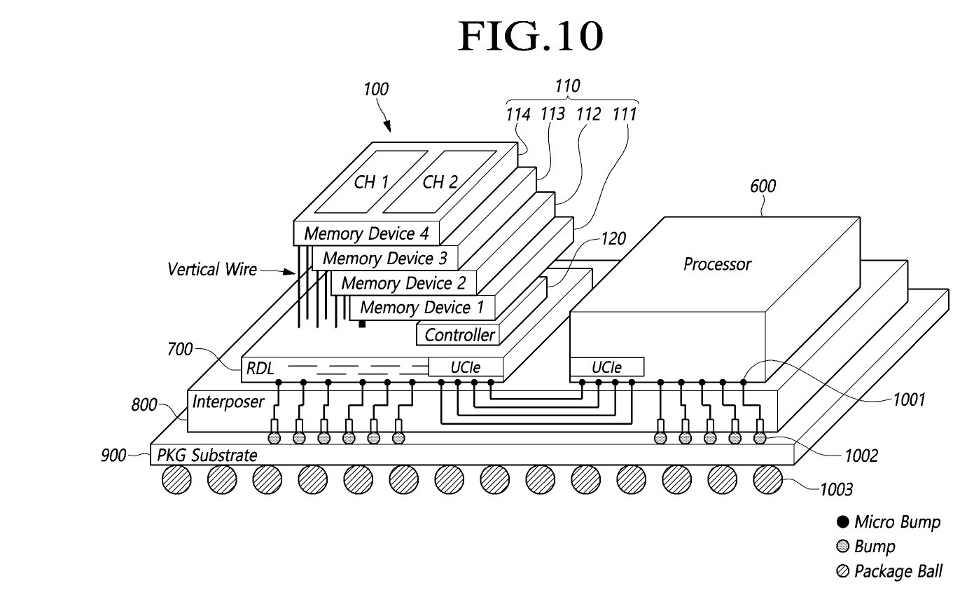

FIG. 10 shows an example of a configuration implementing a computing system including a data storage system according to embodiments of the present disclosure.

Referring to FIG. 10, an example of a semiconductor package structure including a data storage system 100 and a processor 600 is shown. The data storage system 100 includes a memory device 110 that has four numbered memory devices 111, 112, 113, 114 and a controller 120.

In embodiments, a computing system includes a processor 600 and a data storage system 100. Each of the devices in the memory device 110 included in the data storage system 100 may communicate with the controller 120 through two channels. The controller 120 may communicate with each numbered memory device 111 through 114 using two channels, and control the timing of transmitting an operation command based on the occupation status information of a storage area to be operated.

A memory device 110 may be stacked and placed on a controller 120. The controller 120 and the memory device 110 may be placed on a redistribution layer 700. The memory device 110 may be electrically connected to the redistribution layer 700 through, for example, a vertical wire. The redistribution layer 700 may provide a wiring structure in which the controller 120 or the memory device 110 is electrically connected to an interposer 800 located below the redistribution layer 700. The redistribution layer 700 may be electrically connected to the interposer 800 through a micro- bump 1001. A processor 600 may be placed on the interposer 800. The processor 600 may be electrically connected to the interposer 800 through the micro-bumps 1001.

The redistribution layer 700 and the processor 600 on the interposer 800 may be electrically connected through the wiring included in the interposer 800. Through this configuration, the controller 120 and the processor 600 in the data storage system 100 may be electrically connected.

The interposer 800 may be electrically connected to the package substrate 900 through a bump 1002. The package ball 1003 may be located under the package substrate 900. The micro-bump 1001 and bump 1002 may be electrically connected through the interposer 800, and bump 1002 and package ball 1003 may be electrically connected through the package substrate 900.

A compact structure that enables electrical connection between a data storage system 100 and a processor 600 within a single semiconductor package may be achieved by the arrangement of an interposer 800 and a redistribution layer 700.

The data storage system 100 is positioned adjacent to the processor 600, and provides enhanced operating performance through the controller 120, which communicates with the memory device 110 having multiple channels and controls command processing for the memory device 110. The operational performance of a computing system, which includes the processor 600 that processes data using the data storage system 100, can be improved.

Although various embodiments of the disclosed technology have been described with particular specifics and varying details for illustrative purposes, those skilled in the art will appreciate that various modifications, additions and substitutions may be made based on what is disclosed or illustrated in the disclosure herein without departing from the spirit and scope of the invention as defined in the following claims.

What is claimed is:

1. A data storage system comprising:
a plurality of storage areas, including a first storage area and a second storage area, for storing data;
a memory device including a first channel and a second channel for communication; and
a controller for transmitting an operation command to the memory device through at least one of the first channel and the second channel, and for controlling an operation for the first storage area through the first channel during a first time period and controlling an operation for the second storage area through the second channel during a portion of the first time period.

2. The data storage system according to claim 1, wherein the controller transmits an occupation request command for the first storage area to the memory device through at least one of the first channel and the second channel, checks an occupation status information of the first storage area, and controls a timing of transmitting the operation command for the first storage area based on the occupation status information of the first storage area.

3. The data storage system according to claim 2, wherein, when the occupation request command is transmitted through the first channel, the controller transmits the operation command for the first storage area at a first time period if the occupation status information of the first storage area is a first value, and transmits the operation command for the first storage area at a second time period later than the first time period if the occupation status information of the first storage area is a value other than the first value.

4. The data storage system according to claim 3, wherein the controller transmits the occupation request command for the first storage area through the first channel before transmitting the operation command for the first storage area at the second time period.

5. The data storage system according to claim 3, wherein the controller transmits an occupation request command for a third storage area from among the plurality of storage areas through the first channel if the occupation status information of the first storage area is a value other than the first value.

6. The data storage system according to claim 2, wherein the controller transmits a command requesting confirmation of the occupation status information of the first storage area to the memory device after transmitting the occupation request command for the first storage area.

7. The data storage system according to claim 2, wherein the occupation status information of the first storage area is a second value, and wherein the first storage area performs an operation according to an operation command received through the second channel.

8. The data storage system according to claim 2, wherein the memory device comprises:
a first memory device including the first channel and the second channel, and communicating with the controller through the first channel; and
a second memory device including the first channel and the second channel, and communicating with the controller through the second channel.

9. The data storage system according to claim 8, wherein the sum of the number of channels included in the first memory device and the number of channels included in the second memory device is greater than the number of channels included in the controller.

10. The data storage system according to claim 8, wherein the occupation status information of all of the plurality of storage areas included in the first memory device is set to a first value, and
wherein the occupation status information of all of the plurality of storage areas included in the second memory device is set to a second value.

11. The data storage system according to claim 8, wherein the controller transmits the occupation request command before transmitting the operation command to the first memory device and the second memory device.

12. The data storage system according to claim 2, wherein the controller comprises:
a first controller that communicates with the memory device through the first channel and accesses the plurality of storage areas; and
a second controller that communicates with the memory device through the second channel and accesses the plurality of storage areas during a time period other than a time period during which the first controller accesses the plurality of storage areas.

13. The data storage system according to claim 12, wherein the first controller transmits a write command for the first storage area to the memory device during a first period, and
wherein the second controller transmits a read command for the first storage area to the memory device during a second period subsequent to the first period.

14. The data storage system according to claim 13, wherein the first controller transmits an occupation request command for the first storage area to the memory device before transmitting the write command, and
wherein the second controller transmits an occupation request command for the first storage area to the memory device before transmitting the read command.

15. A memory device comprising:
a plurality of storage areas; and
a switching unit that controls connection between each of the plurality of storage areas and N (an integer where N≥2) channels,
wherein the memory device receives an operation command for a first storage area through a first channel, from among the N channels, and
wherein the memory device receives an operation command for a second storage area different from the first storage area through a second channel during at least a portion of a period during which an operation for the first storage area is performed.

16. The memory device according to claim 15, wherein the memory device sets a occupation status information of the first storage area to a first value according to an occupation request command for the first storage area received through the first channel, and wherein the memory device receives the operation command for the first storage area through the first channel.

17. The memory device according to claim 16, wherein the memory device receives the occupation request command for the first storage area through the second channel while an operation according to the operation command is performed for the first storage area, and
wherein the occupation status information of the first storage area is maintained at the first value.

18. The memory device according to claim 17, wherein the memory device receives an occupation request command for the first storage area through the second channel after the operation according to the operation command for the first storage area is terminated,
wherein the occupation status information of the first storage area is changed to a second value, and
wherein the operation command for the first storage area is received through the second channel after the occupation status information of the first storage area is changed to the second value.

19. A controller comprising:
an interface unit that communicates with a memory device through a first channel and a second channel; and
a control logic that transmits an occupation request command for a target storage area through the first channel, checks an occupation status information of the target storage area, and transmits an operation command for the target storage area through the first channel if the occupation status information of the target storage area is a first value.

20. The controller according to claim 19 wherein the control logic transmits the operation command at a first time period when the occupation status information of the target storage area is a first value, and transmits the operation command at a second time period after the first time period when the occupation status information of the target storage area is a second value.
